(19) United States
(12) Patent Application Publication
(10) Pub. No.: US 2022/0077535 A1
(43) Pub. Date: Mar. 10, 2022

(54) ENERGY STORAGE APPARATUS

(71) Applicant: GS Yuasa International Ltd., Kyoto-shi (JP)

(72) Inventors: Tsuyoshi HIDAKA, Kyoto-shi, Kyoto (JP); Yasuyuki IWASHIMA, Kyoto-shi, Kyoto (JP); Shun SASAKI, Kyoto-shi, Kyoto (JP)

(21) Appl. No.: 17/418,496

(22) PCT Filed: Dec. 5, 2019
(86) PCT No.: PCT/JP2019/047529

§ 371 Date: Jun. 25, 2021

(30) Foreign Application Priority Data
Dec. 27, 2018 (JP) 2018-244329

(51) Int. Cl. H01M 50/289; H01M 50/209; H01M 50/296; H01M 50/505

(52) U.S. Cl. CPC H01M 50/289; H01M 50/505; H01M 50/296; H01M 50/209

(57) ABSTRACT

An energy storage apparatus includes an energy storage device, a spacer disposed on a first direction side of the energy storage device, and a bus bar connected to the energy storage device, and at least a part of the bus bar is disposed inside the spacer.

### TECHNICAL FIELD

The present invention relates to an energy storage apparatus including an energy storage device and a bus bar.

### BACKGROUND ART

Conventionally, an energy storage apparatus including an energy storage device and a bus bar is widely known. Patent Document 1 discloses a battery pack (energy storage apparatus) including a battery cell (energy storage device) and a bus bar, the bus bar being supported by a bus bar case.

### PRIOR ART DOCUMENT

### Patent Document

Patent Document 1: JP-A-2018-73551

### SUMMARY OF THE INVENTION

### Problems to be Solved by the Invention

In an energy storage apparatus, it is desired to further reduce the number of components and to provide a simple configuration in order to improve productivity.

An object of the present invention is to provide an energy storage apparatus having a simple configuration.

### Means for Solving the Problems

According to one aspect of the present invention, there is provided an energy storage apparatus including: an energy storage device; a spacer disposed on a side of the energy storage device in a first direction; and a bus bar connected to the energy storage device, in which at least a part of the bus bar is disposed inside the spacer.

The present invention can be realized not only as such an energy storage apparatus but also as the spacer and the bus bar included in the energy storage apparatus.

### Advantages of the Invention

According to the present invention, the energy storage apparatus having a simple configuration can be realized.

### BRIEF DESCRIPTION OF THE DRAWINGS

FIG. 1 is a perspective view illustrating an external appearance of an energy storage apparatus according to an embodiment.

FIG. 2 is an exploded perspective view illustrating respective components when the energy storage apparatus according to the embodiment is disassembled.

FIG. 3 is a perspective view illustrating a configuration of an energy storage device according to the embodiment.

FIG. 4 is a perspective view illustrating configurations of an end spacer and a terminal member according to the embodiment.

FIG. 5 are perspective views illustrating configurations of a terminal block of the end spacer and the terminal member according to the embodiment.

FIG. 6 is a perspective view illustrating a positional relationship among the energy storage devices, the end spacers, end members, bus bars, and the terminal members according to the embodiment.

### MODE FOR CARRYING OUT THE INVENTION

In an energy storage apparatus, it is desired to further reduce the number of components and to provide a simple configuration in order to improve productivity. The conventional energy storage apparatus includes the bus bar case, and the bus bar is supported by the bus bar case. Therefore, there is a problem that the configuration is complicated.

According to one aspect of the present invention, there is provided an energy storage apparatus including: an energy storage device; a spacer disposed on a side of the energy storage device in a first direction; and a bus bar connected to the energy storage device, in which at least a part of the bus bar is disposed inside the spacer.

With such a configuration, in the energy storage apparatus, at least a part of the bus bar which is connected to the energy storage device is disposed inside the spacer. As described above, by disposing at least a part of the bus bar inside the spacer, the bus bar can be supported by the spacer. With such a configuration, it is unnecessary to provide another member such as a bus bar case which supports the bus bar and hence, the energy storage apparatus having a simple configuration can be realized.

The energy storage apparatus may include a plurality of energy storage devices arranged in the first direction, and may include another energy storage device disposed at a position where the spacer is sandwiched between another energy storage device and the energy storage device or at a position where the energy storage device is sandwiched between another energy storage device and the spacer.

With such a configuration, the energy storage apparatus includes another energy storage device which sandwiches the spacer with the energy storage device or sandwiches the energy storage device with the spacer. That is, the spacer is a spacer (intermediate spacer) disposed between two energy storage devices or a spacer (end spacer) disposed on the side of the plurality of energy storage devices. As described above, the energy storage apparatus having a simple configuration can be realized by using the intermediate spacer or the end spacer as the spacer which supports the bus bar.

The bus bar may be a bus bar which connects an electrode terminal of the energy storage device and an external terminal of the energy storage apparatus, and at least a part of the bus bar between the electrode terminal and the external terminal may be disposed inside the spacer.

With such a configuration, the bus bar disposed inside the end spacer is a bus bar which connects the electrode terminal of the energy storage device and the external terminal of the energy storage apparatus, and at least a part of the bus bar between the electrode terminal and the external terminal is disposed inside the end spacer. Since the bus bar which connects the electrode terminal of the energy storage device and the external terminal of the energy storage apparatus tends to have a long length, it is preferable to support a portion between the electrode terminal and the external terminal. Therefore, at least a part of the bus bar between the electrode terminal and the external terminal is disposed inside the end spacer. With such a configuration, the bus bar can be easily supported and hence, the energy storage apparatus having a simple configuration can be realized.

The spacer may include a terminal block on which an external terminal of the energy storage apparatus is disposed.

With such a configuration, the spacer in which the bus bar is disposed includes the terminal block on which the external terminal of the energy storage apparatus is disposed. As described above, since the spacer includes the terminal block for the external terminal, the number of components can be reduced as compared with a case where the terminal block is separately provided. With such a configuration, the energy storage apparatus having a simple configuration can be realized.

The energy storage apparatus may further include an end member disposed at an end of the energy storage apparatus in the first direction, and the terminal block may be disposed on a side of the end member in a second direction intersecting with the first direction.

With such a configuration, the terminal block is disposed on the second direction side, which intersects with the first direction, of the end member disposed at the end of the energy storage apparatus on the first direction side. In order to suppress transfer of heat from the energy storage device or secure an insulating property, it is sometimes preferable that the length of the spacer in the second direction is not shortened. On the other hand, since the length of the end member in the second direction can be made shorter than that of the spacer, the terminal block can be disposed by utilizing the space on the second direction side of the end member. By disposing the terminal block on the second direction side of the end member, it is possible to suppress an increase in the length of the energy storage apparatus in the first direction. With such a configuration, space saving (improvement of the energy density) of the energy storage apparatus can be realized with a simple configuration.

The external terminal may be formed integrally with the terminal block.

With such a configuration, the external terminal of the energy storage apparatus is formed integrally with the terminal block of the spacer. As described above, the number of components can be reduced by integrally forming the external terminal with the terminal block of the spacer. With such a configuration, the energy storage apparatus having a simple configuration can be realized.

The energy storage apparatus may further include a plurality of energy storage devices arranged in the first direction, and the spacer may be disposed outside the energy storage device disposed at an end of the plurality of energy storage devices in the first direction.

With such a configuration, the spacer in which the bus bar is disposed is an end spacer disposed at the end in the first direction. As described above, the energy storage apparatus having a simple configuration can be realized by using the end spacer as the spacer which supports the bus bar.

Hereinafter, an energy storage apparatus according to an embodiment of the present invention (and a modification example thereof) will be described with reference to the drawings. The embodiment described below describes a comprehensive or specific example. The numerical values, shapes, materials, components, arrangement position of the components and connection forms of the components, manufacturing processes, order of manufacturing processes, and the like described in the following embodiment are merely examples, and are not intended to limit the present invention. Among the components in the following embodiment, components that are not described in the independent claim indicating the highest concept are described as optional components. In each drawing, dimensions and the like are not strictly illustrated.

In the following description and drawings, an arrangement direction of the energy storage devices, an arrangement direction of spacers (intermediate spacer, end spacer), an arrangement direction of end members (end plates), an arrangement direction of the energy storage devices, the spacers, and the end members, an opposing direction of a pair of long side surfaces in a case of one energy storage device, or a thickness direction of the energy storage device, the spacer, or the end member is defined as an X-axis direction. An arrangement direction of a case body and a lid of the energy storage device or an arrangement direction of the energy storage device and a bus bar is defined as a Y-axis direction. An arrangement direction of a pair of electrode terminals in one energy storage device, an opposing direction of a pair of short side surfaces in a case of one energy storage device, an arrangement direction of side members (side plates), an arrangement direction of insulating plates, an arrangement direction of the side members and the insulating plates, or a vertical direction is defined as a Z-axis direction. The X-axis direction, the Y-axis direction, and the Z-axis direction are directions intersecting with (orthogonal to in the present embodiment) each other. Although the Z-axis direction may not be the vertical direction depending on the usage mode, the Z-axis direction will be described below as the vertical direction for convenience of description. In the following description, an X-axis plus direction indicates an arrow direction of the X-axis, and an X-axis minus direction indicates a direction opposite to the X-axis plus direction. The same applies to the Y-axis direction and the Z-axis direction. Hereinafter, the X-axis direction (or the X-axis plus direction) is also referred to as a first direction, and the Y-axis plus direction is also referred to as a second direction.

### Embodiment

### 1 General Description of Energy Storage Apparatus 10

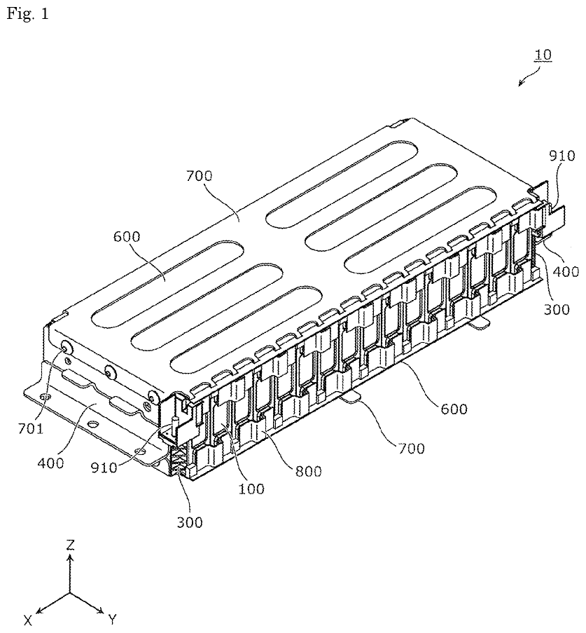

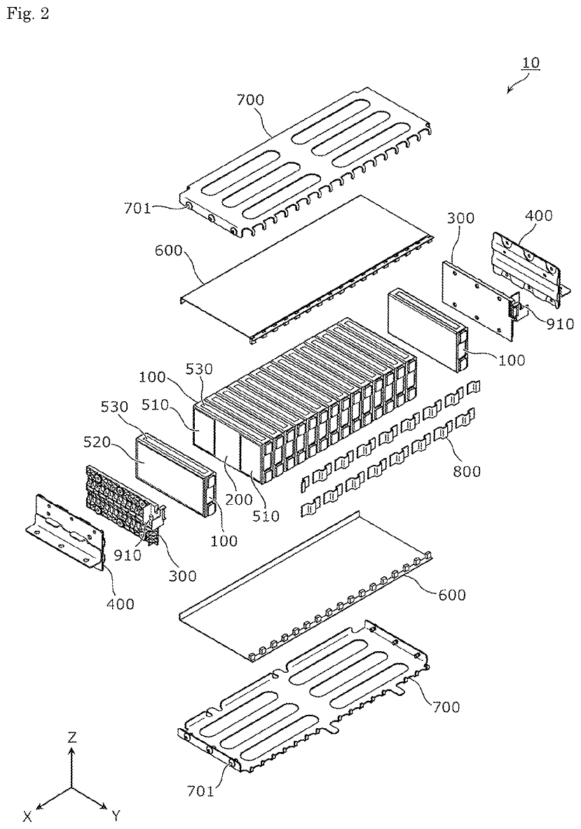

First, a configuration of an energy storage apparatus 10 will be described. FIG. 1 is a perspective view illustrating an external appearance of the energy storage apparatus 10 according to the present embodiment. FIG. 2 is an exploded perspective view illustrating respective components when the energy storage apparatus 10 according to the present embodiment is disassembled.

The energy storage apparatus 10 is an apparatus capable of being charged with electricity from the outside and discharging electricity to the outside, and has a substantially rectangular parallelepiped shape in the present embodiment. The energy storage apparatus 10 is a battery module (assembled battery) used for power storage applications, power supply applications, and the like. Specifically, the energy storage apparatus 10 is used as a stationary battery for driving or starting an engine of a moving body such as an automobile such as an electric vehicle (EV), a hybrid electric vehicle (HEV), or a plug-in hybrid electric vehicle (PHEV), a motorcycle, a watercraft, a snowmobile, an agricultural machine, a construction machine, or a railway vehicle for an electric railway such as a train, a monorail, or a linear motor car, or for home use or a generator.

As illustrated in FIG. 1 and FIG. 2, the energy storage apparatus 10 includes a plurality of (sixteen in the present embodiment) energy storage devices 100, a plurality of (fifteen in the present embodiment) intermediate spacers 200, a pair of end spacers 300, a pair of end members 400, a pair of insulating plates 600, a pair of side members 700, and bus bars 800. Adhesive layers 510 are disposed between the adjacent energy storage devices 100, an adhesive layer 520 is disposed between the energy storage device 100 and the end spacer 300, and adhesive layers 530 are disposed between the energy storage devices 100 and the insulating plate 600. The energy storage apparatus 10 may also include a bus bar frame for holding the bus bars 800, wiring for measuring a voltage of the energy storage devices 100, wiring for measuring a temperature, a thermistor, a circuit board for monitoring a charged state or a discharged state of the energy storage devices 100, electric equipment such as a relay, and the like.

The energy storage device 100 is a secondary battery (battery cell) capable of being charged with electricity and discharging electricity, and more specifically, is a nonaqueous electrolyte secondary battery such as a lithium ion secondary battery. The energy storage devices 100 have a flat rectangular parallelepiped (prismatic) shape, and are arranged side by side in the X-axis direction in a state where the energy storage devices 100 are laid down such that long side surfaces face in the X-axis direction and the electrode terminals face in the Y-axis plus direction. The energy storage device 100 is disposed adjacent to the intermediate spacer 200 or the end spacer 300. That is, each of the plurality of energy storage devices 100 is alternately disposed with each of the plurality of intermediate spacers 200 and the pair of end spacers 300, and is arranged in the X-axis direction. In the present embodiment, fifteen intermediate spacers 200 are each disposed between the adjacent energy storage devices 100 of the sixteen energy storage devices 100, and the pair of end spacers 300 are disposed at positions sandwiching the energy storage devices 100 disposed at ends of the sixteen energy storage devices 100. The configuration of the energy storage device 100 will be described in detail later.

The number of the energy storage devices 100 is not particularly limited, and may be plural other than sixteen or may be one. The shape of the energy storage device 100 is not particularly limited, and may be any shape such as a polygonal columnar shape other than a rectangular parallelepiped shape, a cylindrical shape, an elliptical columnar shape, or an oval columnar shape, or the energy storage device 100 may be a laminate-type energy storage device. The energy storage device 100 is not limited to the nonaqueous electrolyte secondary battery, and may be a secondary battery other than the nonaqueous electrolyte secondary battery, or may be a capacitor. The energy storage device 100 may not be a secondary battery but a primary battery that can use stored electricity without being charged by a user. The energy storage device 100 may be a battery using a solid electrolyte.

The intermediate spacer 200 and the end spacer 300 are spacers which are disposed on the side (the X-axis plus direction or the X-axis minus direction) of the energy storage device 100, insulate the energy storage device 100 from other members, and suppress expansion of the energy storage device 100. The intermediate spacer 200 and the end spacer 300 are formed of an insulating resin material such as polycarbonate (PC), polypropylene (PP), polyethylene (PE), a polyphenylene sulfide resin (PPS), polyethylene terephthalate (PET), polyether ether ketone (PEEK), tetrafluoroethylene-perfluoroalkyl vinyl ether (PFA), polytetrafluoroethylene (PTFE), polybutylene terephthalate (PBT), polyether sulfone (PES), an ABS resin, or a composite material thereof. The intermediate spacer 200 and the end spacer 300 may be formed of a material other than resin as long as the material has an insulating property, and may be formed of a ceramic, a mica plate formed of a dammar material configured by accumulating and bonding mica pieces, or the like. All of the plurality of intermediate spacers 200 and the pair of end spacers 300 may not be formed of the same material.

The intermediate spacer 200 is a rectangular flat-plate-like spacer which is disposed at a center position of the energy storage device 100 in the Y-axis direction while being sandwiched between two adjacent energy storage devices 100. That is, the intermediate spacer 200 is disposed at a position sandwiched between one energy storage device 100 and the other energy storage device 100. The adhesive layers 510 such as double-sided tapes are disposed on both sides of the intermediate spacer 200 in the Y-axis direction, and the energy storage devices 100 on both sides of the intermediate spacer 200 in the X-axis direction are adhered to each other by the adhesive layers 510. With such a configuration, the intermediate spacer 200 is fixed to the energy storage devices 100 on both sides in the X-axis direction by being sandwiched between the energy storage devices 100 on both sides in the X-axis direction. In the present embodiment, fifteen intermediate spacers 200 are arranged corresponding to sixteen energy storage devices 100. However, when the number of the energy storage devices 100 is other than sixteen, the number of the intermediate spacers 200 is also changed according to the number of the energy storage devices 100.

The end spacer 300 is a rectangular plate-like spacer which is disposed to be sandwiched between the energy storage device 100 at the end and the end member 400. That is, the end spacer 300 is disposed at a position where one energy storage device 100 is sandwiched between the end spacer 300 and another energy storage device 100. Since the end spacer 300 is formed of an insulating material as described above, the end spacer 300 has a function as an insulating layer extending in the Y-axis direction and the Z-axis direction. The end spacer 300 is a member having higher elasticity (Low Young's modulus or low stiffness) than the end member 400. The adhesive layer 520 such as a double-sided tape is disposed on the energy storage device 100 side of the end spacer 300, and the end spacer 300 and the energy storage device 100 are adhered to each other by the adhesive layer 520.

On the end spacers 300, a pair of external terminals 910 which are terminals of the energy storage apparatus 10 are disposed. The pair of external terminals 910 are a positive electrode external terminal and a negative electrode external terminal of the energy storage apparatus 10, and each are a part of a terminal member 900 described later. The configurations of the end spacer 300 and the external terminal 910 (terminal member 900) will be described in detail later.

The end members 400 and the side members 700 are members which press the energy storage devices 100 from the outward in the direction in which the plurality of energy storage devices 100 are arranged (X-axis direction). That is, the end members 400 and the side members 700 press the respective energy storage devices 100 included in the plurality of energy storage devices 100 from both sides in the arrangement direction by sandwiching the plurality of energy storage devices 100 from both sides in the arrangement direction.

Specifically, the end members 400 are plate-like end plates (sandwiching members) which are disposed on both sides of the plurality of energy storage devices 100 in the X-axis direction and sandwich and hold the plurality of energy storage devices 100 from both sides in the arrangement direction (X-axis direction) of the plurality of energy storage devices 100. The end member 400 is made of a metal (conductive) material such as stainless steel, iron, a plated steel plate, aluminum, or an aluminum alloy from a viewpoint of securing strength. A material of the end member 400 is not particularly limited, and may be formed of an insulating material having high strength, or may be subjected to an insulation treatment. The end member 400 may be a block-like end block or the like instead of the plate-like end plate.

The side members 700 are each an elongated plate-like side plate (restraint member, restraint bar) of which both ends are attached to the end members 400 and which restrain the plurality of energy storage devices 100. That is, the side members 700 are disposed to extend in the X-axis direction so as to straddle the plurality of energy storage devices 100, the plurality of intermediate spacers 200, and the pair of end spacers 300, and apply a restraint force in the arrangement direction (X-axis direction) to the plurality of energy storage devices 100 and the like. In the present embodiment, on both sides of the plurality of energy storage devices 100 in the Z-axis direction, the two side members 700 are each disposed at a position where the insulating plate 600 is sandwiched between the side member 700 and the energy storage devices 100. At both ends in the X-axis direction, the two side members 700 are respectively attached to ends of the two end members 400 in the Z-axis direction. With such a configuration, the two side members 700 sandwich and restrain the plurality of energy storage devices 100 and the like from both sides in the X-axis direction and both sides in the Z-axis direction.

The side member 700 is fixed to the end member 400 by a plurality of fixing members 701 such as bolts arranged in the Y-axis direction. The attachment of the side member 700 to the end member 400 is not limited to fixing with bolts or the like, and the side member 700 may be fixed (joined) by welding, adhesion, riveting, caulking, or the like. The side member 700 may be formed of any material, but is formed of a material similar to the material of the end member 400 from the viewpoint of securing strength and the like. The side member 700 may be a block-like or rod-like member or the like instead of the plate-like side plate.

The insulating plates 600 are elongated flat-plate-like insulating members (insulators) which are disposed on both sides of the plurality of energy storage devices 100 in the Z-axis direction and extend in the X-axis direction. That is, the insulating plate 600 is disposed between the plurality of energy storage devices 100, the plurality of intermediate spacers 200, and the pair of end spacers 300 and the side member 700 so as to straddle the plurality of energy storage devices 100 and the like, and insulates the energy storage devices 100 from the side member 700. The adhesive layers 530 such as double-sided tapes are disposed between the energy storage devices 100 and the insulating plate 600, and the energy storage devices 100 and the insulating plate 600 are adhered to each other by the adhesive layers 530. The insulating plate 600 may be formed of any material as long as it is a member having an insulating property, but is formed of a material similar to the material of the intermediate spacer 200 and the end spacer 300. The two insulating plates 600 may be formed of different materials.

The bus bars 800 are conductive plate-like members which are disposed on the plurality of energy storage devices 100 and electrically connect the electrode terminals of the plurality of energy storage devices 100 to each other. In the present embodiment, the bus bars 800 connect the positive electrode terminal and the negative electrode terminal of the adjacent energy storage devices 100 in series to connect the plurality of energy storage devices 100 in series. The external terminals 910 on the positive electrode side and the negative electrode side are connected to the bus bars 800 disposed at the ends. The bus bar 800 is formed of a conductive member made of metal such as aluminum, an aluminum alloy, copper, or a copper alloy. The connection form of the energy storage devices 100 is not particularly limited, and any of the energy storage devices 100 may be connected in parallel.

### 2 Detailed Description of Energy Storage Device 100

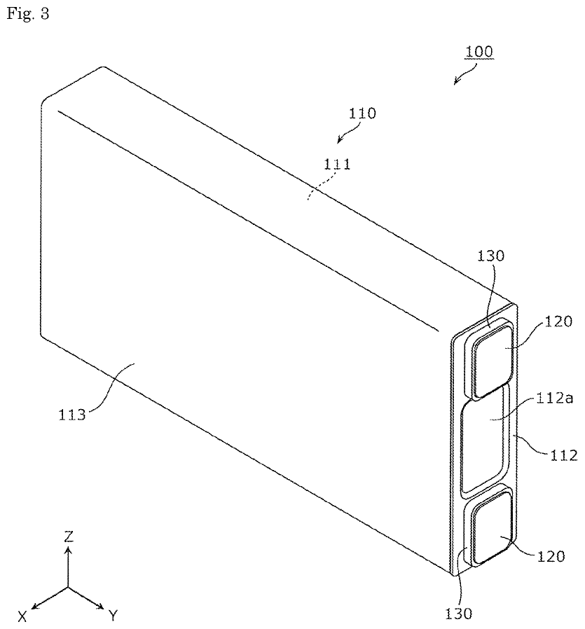

Next, the configuration of the energy storage device 100 will be described in detail. FIG. 3 is a perspective view illustrating the configuration of the energy storage device 100 according to the present embodiment. Specifically, FIG. 3 is an enlarged perspective view illustrating a state where the intermediate spacer 200 and the adhesive layers 510, 520, and 530 are removed from the energy storage device 100 in FIG. 2. Since all the sixteen energy storage devices 100 in FIG. 2 have the same configuration, one energy storage device 100 will be described below.

As illustrated in FIG. 3, the energy storage device 100 includes a case 110, a pair of electrode terminals 120 (a positive electrode terminal and a negative electrode terminal), and a pair of gaskets 130 (gaskets on a positive electrode side and a negative electrode side). Although an electrode assembly, a pair of current collectors (a positive electrode current collector and a negative electrode current collector), an electrolyte solution (nonaqueous electrolyte), and the like are accommodated in the case 110, illustration thereof is omitted. A kind of the electrolyte solution is not particularly limited as long as performance of the energy storage device 100 is not impaired, and various kinds of electrolyte solutions can be selected. A gasket is also disposed between the case 110 (a lid body 112 described later) and the current collector, and a spacer is disposed on a side of the current collector or the like, but illustration thereof is also omitted.

The case 110 is a rectangular parallelepiped (prismatic) case including a case body 111 in which an opening is formed, the lid body 112 that closes the opening of the case body 111, and an insulating sheet 113 that covers an outer surface of the case body 111. The case body 111 is a member having a bottom and a rectangular cylindrical shape constituting the body portion of the case 110, and has an opening formed on the Y-axis plus direction side. The lid body 112 is a rectangular plate-like member constituting a lid portion of the case 110, and is disposed to extend in the Z-axis direction on the Y-axis plus direction side of the case body 111. The lid body 112 is provided with a gas release valve 112a that releases a pressure inside the case 110 when the pressure increases, an electrolyte solution filling portion (not illustrated) for filling an electrolyte solution inside the case 110, and the like. The material of the case body 111 and the lid body 112 is not particularly limited, but is preferably a weldable metal such as stainless steel, aluminum, an aluminum alloy, iron, or a plated steel plate.

The insulating sheet 113 is an insulating sheet-like member disposed on the outer surface of the case body 111 and covering the outer surface of the case body 111. The material of the insulating sheet 113 is not particularly limited as long as an insulating property required for the energy storage device 100 can be secured, and examples thereof include an insulating resin such as PC, PP, PE, PPS, PET, PBT, or an ABS resin, epoxy resin, Kapton, Teflon (registered trademark), silicon, polyisoprene, and polyvinyl chloride.

As described above, the electrode assembly and the like are accommodated in the inside of the case body 111, the case body 111 and the lid body 112 are joined by welding or the like to seal the inside, and the insulating sheet 113 is disposed on the outer surface of the case body 111 to form the case 110.

The electrode terminals 120 are terminals (the positive electrode terminal and the negative electrode terminal) of the energy storage device 100 which are disposed on the lid body 112, and are electrically connected to a positive electrode plate and a negative electrode plate of the electrode assembly through the current collectors. That is, the electrode terminal 120 is a metal member for leading out electricity stored in the electrode assembly to a space outside the energy storage device 100 and for introducing electricity into a space inside the energy storage device 100 so as to store electricity in the electrode assembly. The electrode terminal 120 is made of aluminum, an aluminum alloy, copper, a copper alloy, or the like. The gasket 130 is disposed around the electrode terminal 120 and between the electrode terminal 120 and the lid body 112, and is a member for ensuring an insulating property and airtightness between the electrode terminal 120 and the lid body 112. The gasket 130 is made of an insulating material such as PP, PE, PPS, PET, PEEK, PFA, PTFE, PBT, PES, or an ABS resin.

The electrode assembly is an energy storage element (power generating element) formed by stacking the positive electrode plate, the negative electrode plate, and a separator. The positive electrode plate included in the electrode assembly is formed by forming a positive active material layer on a positive electrode substrate layer which is an elongated strip-shaped current collecting foil made of metal such as aluminum or an aluminum alloy. The negative electrode plate is obtained by forming a negative active material layer on a negative electrode substrate layer which is an elongated strip-shaped current collecting foil made of metal such as copper or a copper alloy. As a positive active material used for the positive active material layer and a negative active material used for the negative active material layer, known materials can be appropriately used as long as they can occlude and discharge lithium ions. The current collectors are members having conductivity and rigidity (the positive electrode current collector and the negative electrode current collector), and are electrically connected to the electrode terminals 120 and the electrode assembly. The positive electrode current collector is made of aluminum, an aluminum alloy, or the like similarly to the positive electrode substrate layer of the positive electrode plate, and the negative electrode current collector is made of copper, a copper alloy, or the like similarly to the negative electrode substrate layer of the negative electrode plate.

3 Detailed Description of Configurations of End Spacer 300 and Terminal Member 900

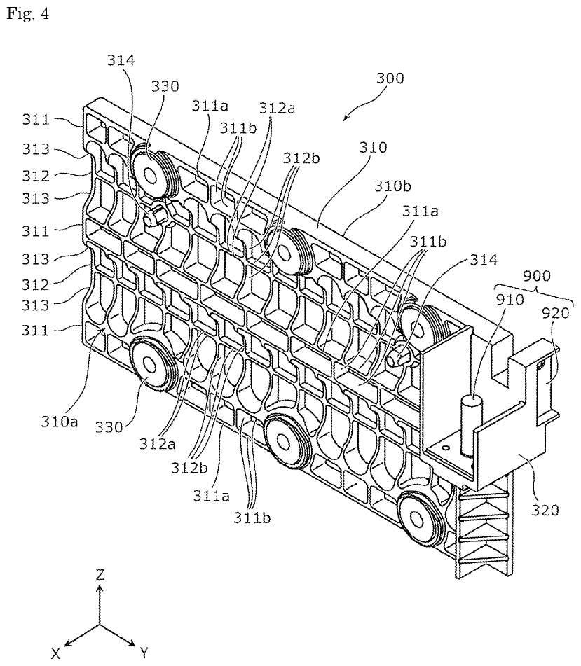

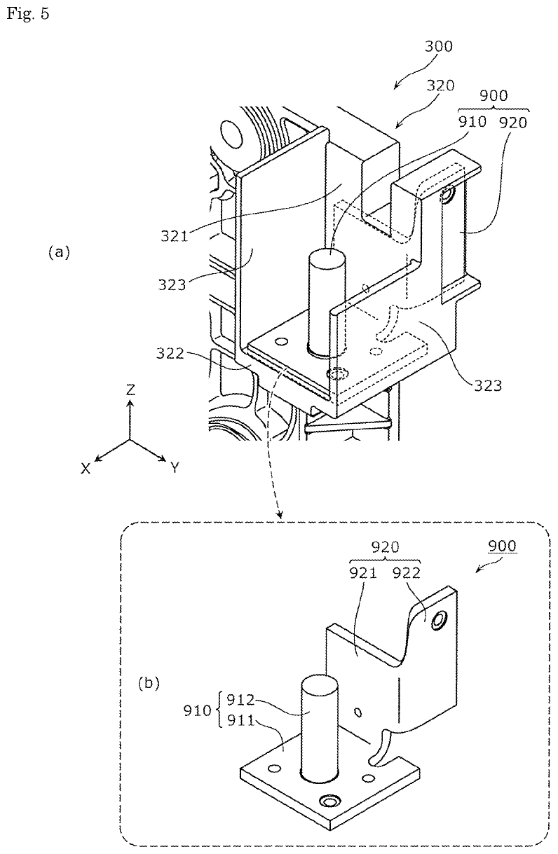

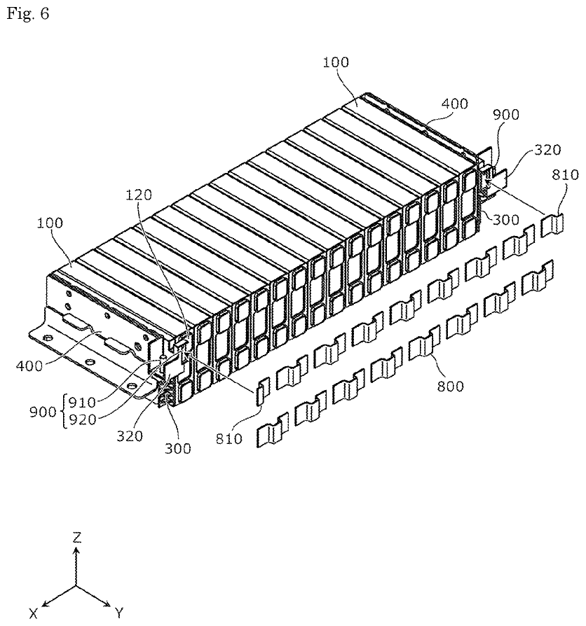

Next, the configurations of the end spacer 300 and the terminal member 900 will be described in detail. FIG. 4 is a perspective view illustrating the configurations of the end spacer 300 and the terminal member 900 according to the present embodiment. Specifically, FIG. 4 is a perspective view illustrating the end spacer 300 on the X-axis plus direction side in FIG. 2 together with the terminal member 900 including the external terminal 910. FIG. 5 are perspective views illustrating configurations of a terminal block 320 of the end spacer 300 and the terminal member 900 according to the present embodiment. Specifically, FIG. 5(a) is an enlarged perspective view illustrating enlarged configurations of the terminal block 320 and the terminal member 900 illustrated in FIG. 4, and FIG. 5(b) is a perspective view illustrating the configuration of the terminal member 900. FIG. 6 is a perspective view illustrating a positional relationship among the energy storage devices 100, the end spacers 300, the end members 400, the bus bars 800, and the terminal members 900 according to the present embodiment. In FIG. 2, since the end spacer 300 and the like on the X-axis plus direction side and the end spacer 300 and the like on the X-axis minus direction side have symmetrical shapes with respect to the YZ plane, the description of the end spacer 300 and the like on the X-axis minus direction side is omitted.

The end spacer 300 is a spacer disposed on the X-axis plus direction (first direction) side of the energy storage device 100, and includes a spacer body portion 310, the terminal block 320, and spacer projecting portions 330 as illustrated in FIG. 4. The spacer body portion 310 is a plate-like portion constituting a body portion of the end spacer 300, and has a spacer uneven surface 310a having an uneven shape (a wavy waveform shape in the Z-axis direction) on a surface on the X-axis plus direction side, and a flat (planar) spacer flat surface 310b on a surface on the X-axis minus direction side.

The spacer body portion 310 includes spacer convex parts 311, spacer concave parts 312, and spacer inclined portions 313. The spacer convex parts 311 are convex parts which project in the X-axis plus direction of the spacer body portion 310, and three spacer convex parts 311 which are located at an end of the spacer body portion 310 on the Z-axis plus direction side, an end thereof on the Z-axis minus direction side, and a center portion thereof in the Z-axis direction are disposed to extend in the Y-axis direction. The spacer concave parts 312 are concave parts of the spacer body portion 310 which are concaved in the X-axis minus direction, and two spacer concave parts 312 which are each located between two adjacent spacer convex parts 311 of the three spacer convex parts 311 are disposed to extend in the Y-axis direction. The spacer inclined portions 313 are portions having a shape gently inclined from the spacer convex part 311 toward the spacer concave part 312, and four spacer inclined portions 313 which are each located between the spacer convex parts 311 and the spacer concave part 312 are disposed to extend in the Y-axis direction.

Specifically, the spacer convex part 311 is formed with a plurality of recessed portions 311a which are recessed in the X-axis minus direction and are arranged in the Y-axis direction, and hence the spacer convex part 311 has a shape in which a plurality of ribs 311b which extend in the Y-axis direction or the Z-axis direction and are arranged in the Y-axis direction are formed. Similarly, the spacer concave part 312 is formed with a plurality of recessed portions 312a which are recessed in the X-axis minus direction and are arranged in the Y-axis direction and the Z-axis direction, and hence the spacer concave part 312 has a shape in which a plurality of ribs 312b which extend in the Y-axis direction or the Z-axis direction and are arranged in the Y-axis direction are formed. The spacer inclined portions 313 are portions each connecting the spacer convex part 311 and the spacer concave part 312. That is, the spacer inclined portion 313 has an inclined shape in which an end on the Z-axis plus direction side is connected to the spacer convex part 311 and an end on the Z-axis minus direction side is connected to the spacer concave part 312 so that the shape gradually changes from the convex part to the concave part.

The spacer body portion 310 has two spacer-side fitting portions 314 arranged in the Y-axis direction. The spacer-side fitting portions 314 are columnar portions projecting toward the X-axis plus direction side, and are inserted into and fitted to through holes formed in the end member 400 to fix the end spacer 300 to the end member 400.

The spacer projecting portions 330 are each a cylindrical member which is accommodated in a concave part formed in the spacer body portion 310 and in which a part on the X-axis plus direction side projects in the X-axis plus direction. Specifically, the spacer projecting portions 330 are collars to which the fixing members 701 are fastened to fix the side member 700 to the end spacer 300 and the end member 400. In the present embodiment, three spacer projecting portions 330 are disposed on each of ends of spacer body portion 310 on the Z-axis plus direction side and the Z-axis minus direction side.

The terminal block 320 is a pedestal portion which is provided at an end of the end spacer 300 on the Y-axis plus direction side and on which the external terminal 910 is disposed. In the present embodiment, the terminal member 900 including the external terminal 910 is formed integrally with the terminal block 320. The terminal member 900 is a conductive member made of metal such as aluminum, an aluminum alloy, copper, a copper alloy, iron, steel, or stainless steel. Specifically, the terminal member 900 is formed integrally with the end spacer 300 by being insert-molded in the end spacer 300. That is, resin is injected into a mold in which the terminal member 900 is disposed to form an integrally molded product including the terminal member 900 and the end spacer 300. The configurations of the terminal block 320 and the terminal member 900 will be described in detail below.

As illustrated in FIG. 5(a), the terminal block 320 includes a terminal block first wall portion 321, a terminal block second wall portion 322, and two terminal block third wall portions 323. As illustrated in FIG. 5(b), the terminal member 900 includes the external terminal 910 and a bus bar 920.

The terminal block first wall portion 321 is a flat-plate-like wall portion which is disposed on the X-axis minus direction side of the external terminal 910 and accommodates the bus bar 920 therein. The terminal block second wall portion 322 is a rectangular flat-plate-like bottom wall portion which is disposed on the Z-axis minus direction side of the external terminal 910 and on which the external terminal 910 is placed. The terminal block third wall portions 323 are rectangular flat-plate-like side wall portions which are disposed on both sides of the external terminal 910 in the Y-axis direction and surround both sides of the external terminal 910 in the Y-axis direction. In this manner, the terminal block 320 covers the periphery of the terminal member 900 to suppress contact of the terminal member 900 with other members.

The external terminal 910 is a terminal portion connected to a conductive member outside the energy storage apparatus 10, and includes a terminal plate portion 911 having a rectangular flat-plate-like shape parallel to the XY plane, and a terminal column portion 912 having a columnar shape extending from the terminal plate portion 911 in the Z-axis plus direction. The terminal plate portion 911 is a body portion of the external terminal 910, and the external conductive member is connected to the upper surface thereof. The terminal column portion 912 is a portion for fixing the external conductive member to the terminal plate portion 911, and is a bolt portion to be screwed with a nut.

The external terminal 910 is fixed to the terminal block 320 in a state where a surface of the terminal plate portion 911 on the Z-axis plus direction side and the terminal column portion 912 are exposed from the terminal block 320. That is, the external terminal 910 is formed integrally (integrated) with the terminal block 320 by embedding a portion of the terminal plate portion 911 on the Z-axis minus direction side in the terminal block second wall portion 322.

The bus bar 920 is a bus bar which connects the external terminal 910 and the energy storage device 100 to each other, and includes a rectangular flat-plate-like external terminal side plate portion 921 parallel to the YZ plane, and a rectangular flat-plate-like energy storage device side plate portion 922 parallel to the XZ plane. The external terminal side plate portion 921 is connected to the external terminal 910 by connecting an end of the external terminal side plate portion 921 on the Z-axis minus direction side to an end of the terminal plate portion 911 on the X-axis minus direction side of the external terminal 910. The energy storage device side plate portion 922 is connected to the external terminal side plate portion 921 by connecting an end of the energy storage device side plate portion 922 on the X-axis plus direction side to an end of the external terminal side plate portion 921 on the Y-axis plus direction side.

The bus bar 920 is fixed to the terminal block 320 in a state where a surface of the energy storage device side plate portion 922 on the Y-axis plus direction side is exposed from the terminal block 320. That is, the bus bar 920 is formed integrally (integrated) with the terminal block 320 by disposing (embedding) the external terminal side plate portion 921 and the portion of the energy storage device side plate portion 922 on the Y-axis minus direction side in the terminal block first wall portion 321. As described above, at least a part of the bus bar 920 is disposed inside the end spacer 300.

As illustrated in FIG. 6, the exposed surface of the energy storage device side plate portion 922 on the Y-axis plus direction side is connected to the energy storage device 100. Specifically, the energy storage device side plate portion 922 is connected (joined) to a bus bar 810 disposed at an end of the bus bars 800 by welding or the like, and the bus bar 810 is connected (joined) to the electrode terminal 120 of the energy storage device 100 by welding or the like. With such a configuration, the energy storage device side plate portion 922 is electrically connected to the electrode terminal 120 of the energy storage device 100 through the bus bar 810.

As described above, the bus bar 920 is a bus bar which connects the electrode terminal 120 of the energy storage device 100 and the external terminal 910 of the energy storage apparatus 10 by connecting the energy storage device side plate portion 922 to the electrode terminal 120 of the energy storage device 100 and connecting the external terminal side plate portion 921 to the external terminal 910. Therefore, at least a part of the bus bar 920 between the electrode terminal 120 and the external terminal 910 is disposed inside the end spacer 300.

The terminal block 320 projects in the X-axis plus direction from an end of the spacer body portion 310 on the Y-axis plus direction side. That is, as illustrated in FIG. 6, the terminal block 320 projects in a direction directed to the end member 400 disposed at the end of the energy storage apparatus 10 on the X-axis direction (first direction) side. With such a configuration, the terminal block 320 is disposed on the Y-axis plus direction (the second direction which intersects with the first direction) side of the end member 400.

### 4 Description of Effects

As has been described heretofore, according to the energy storage apparatus 10 of the present embodiment, at least a part of the bus bar 920 which is connected to the energy storage device 100 is disposed inside the end spacer 300. As described above, by disposing at least a part of the bus bar 920 inside the end spacer 300, the bus bar 920 can be supported by the end spacer 300. With such a configuration, it is unnecessary to provide another member such as a bus bar case (a bus bar frame or a bus bar plate) which supports the bus bar 920 and hence, the energy storage apparatus 10 having a simple configuration can be realized. In particular, when the bus bar 920 is attached to another member (the electrode terminal 120 of the energy storage device 100, the external terminal 910 of the energy storage apparatus 10, or the like), the position of the bus bar 920 is restricted inside the end spacer 300, so that the bus bar 920 can be prevented from rotating or moving. Since the end spacer 300 is an insulating member, an insulating property between the bus bar 920 and other members (the energy storage device 100, the side member 700, the end member 400, and the like) can be improved.

The spacer in which the bus bar 920 is disposed is the end spacer 300 disposed on the first direction side of the plurality of energy storage devices 100. As described above, the energy storage apparatus 10 having a simple configuration can be realized by using the end spacer 300 as the spacer which supports the bus bar 920.

The bus bar 920 disposed inside the end spacer 300 is a bus bar which connects the electrode terminal 120 of the energy storage device 100 and the external terminal 910 of the energy storage apparatus 10, and at least a part of the bus bar 920 between the electrode terminal 120 and the external terminal 910 is disposed inside the end spacer 300. Since the bus bar 920 which connects the electrode terminal 120 of the energy storage device 100 and the external terminal 910 of the energy storage apparatus 10 tends to have a long length, it is preferable to support a portion between the electrode terminal 120 and the external terminal 910. Therefore, at least a part of the bus bar 920 between the electrode terminal 120 and the external terminal 910 is disposed inside the end spacer 300. With such a configuration, the bus bar 920 can be easily supported and hence, the energy storage apparatus 10 having a simple configuration can be realized. Since the bus bar 920 tends to have a long length, it is preferable to secure position regulation or an insulating property. Therefore, by disposing at least a part of the bus bar 920 between the electrode terminal 120 and the external terminal 910 inside the end spacer 300, it is possible to easily regulate the position of the bus bar 920 and improve the an insulating property with other members.

More specifically, it is as follows. The external terminal 910 has a structure in which an external conductive member such as an external electric wire is attached to the terminal column portion 912 which is a bolt portion, and a nut is fastened to connect the external conductive member. Therefore, when the external conductive member is attached, fastening torque is always applied to the bus bar 920 by a force for fastening the nut.

When the bus bar 920 is not disposed inside the end spacer 300 but is disposed along or straddling a support portion and a guide portion provided in the end spacer 300, the surface of the bus bar 920 is exposed to the outside, and a gap for assembling the bus bar 920 to the end spacer 300 is generated. Therefore, when fastening torque is applied to the bus bar 920 at the time of attaching the external conductive member, the bus bar 920 itself is twisted at the portion of the gap. With such a configuration, when the bus bar 920 is fastened with an excessive force, the bus bar 920 itself may not withstand the twisting force and may be damaged. There is a fear that the bus bar 920 bites into and damages the support portion and the guide portion of the end spacer 300, or gets over the support portion and the guide portion to approach or come into contact with another member. The bus bar 920 which connects the electrode terminal 120 and the external terminal 910 tends to have a long length. Therefore, such a defect is likely to occur as compared with the bus bar 800 which connects the energy storage devices 100 to each other, and it is preferable to support an intermediate portion with sufficient strength.

Thus, by disposing a part of the bus bar 920 inside the end spacer 300, the bus bar 920 can be easily supported with sufficient mechanical strength. If the method of disposing a part of the bus bar 920 inside the end spacer 300 is insert molding, the bus bar 920 and the resin of the end spacer 300 around the bus bar 920 are in close contact with each other without any gap, so that the torque applied to the bus bar 920 can be received by the entire resin of the end spacer 300 around the bus bar 920, and the bus bar 920 can be supported more firmly.

A total voltage of the energy storage apparatus 10 is applied to the bus bar 920 connecting the electrode terminal 120 and the external terminal 910, and the voltage tends to be high. Therefore, in the conventional configuration, the withstand voltage strength may deteriorate even in a normal use state due to the influence of moisture, dew condensation, and the like, and when a failure associated with connection of an external conductive member occurs, sufficient withstand voltage strength cannot be secured, and a leakage current may occur, or in the worst case, a short circuit may occur between a bus bar and another metal portion such as an end member, so that the function of an energy storage apparatus may be impaired. On the other hand, in the present embodiment, since a part of the bus bar 920 is disposed inside the end spacer 300, the bus bar 920 is prevented from getting over the end spacer 300 and approaching or coming into contact with another member, and sufficient withstand voltage strength can be easily secured. If the method of disposing a part of the bus bar 920 inside the end spacer 300 is insert molding, the bus bar 920 and the resin of the end spacer 300 around the bus bar 920 are in close contact with each other without any gap, and the mechanical strength for supporting the bus bar 920 is also improved. Therefore, sufficient withstand voltage strength can be secured, and occurrence of a leakage current and a spark caused by the gap between the bus bar 920 and the end spacer 300 can be prevented.

The end spacer 300 in which the bus bar 920 is disposed includes the terminal block 320 on which the external terminal 910 of the energy storage apparatus 10 is disposed. As described above, since the end spacer 300 includes the terminal block 320 for the external terminal 910, the number of components can be reduced as compared with a case where the terminal block 320 is separately provided. Accordingly, the energy storage apparatus 10 having a simple configuration can be realized. Since it is possible to suppress an increase in the length of the energy storage apparatus 10 in the first direction as compared with the case where the terminal block 320 is provided on the end member 400, space saving (improvement in energy density) can be achieved.

More specifically, it is as follows. In the development of the energy storage apparatus 10, improvement of energy density (specifically, shortening of the overall length of the energy storage apparatus 10) has been the most important issue. Therefore, the inventor of the present application drastically reviewed the members (the intermediate spacers 200, the end spacers 300, the end members 400, the external terminals 910, and the like) constituting the energy storage apparatus 10. The inventor of the present application has found that by forming the end spacer 300 into the shape as in the present embodiment, the stress from the end spacer 300 to the end member 400 is dispersed, and the overall length of the energy storage apparatus 10 can be shortened.

Conventionally, an external terminal provided on a terminal block formed of an insulating block is generally disposed outside an end member, and as the end spacer, a thin resin member has been used as a member for insulating an energy storage device and the end member. (Conversely, when a thin member is not used for the end spacer, the total overall length of an energy storage apparatus including up to the terminal block of the external terminal tends to increase.) According to the “structure of stress dispersion from the end spacer 300 to the end member 400” found by the inventor of the present application, it has been found that a member having a certain thickness and strength is effective in order to provide the end spacer 300 with a shape (uneven shape) that produces a load dispersion effect.

From such a background, the inventor of the present application has arrived at the invention of integrally providing the terminal block 320 for the external terminal 910 on the end spacer 300. That is, by providing the terminal block 320 for the external terminal 910 on the end spacer 300, not only the number of components can be simply reduced, but also the strength, assembling accuracy, and the like of the terminal block 320 itself are improved as compared with the case where the terminal block 320 as a separate member is disposed, the total overall length of the energy storage apparatus 10 including up to the terminal block 320 for the external terminal 910 is made smaller than the conventional cases, and the energy density is successfully improved. Since the terminal block 320 is integrated with the end spacer 300, sufficient withstand voltage strength can be secured, and occurrence of a leakage current and a spark caused by a gap between the terminal block 320 and another member such as the end spacer 300 can also be prevented.

The terminal block 320 is disposed on the second direction (Y-axis plus direction) side, which intersects with the first direction, of the end member 400 disposed at the end of the energy storage apparatus 10 on the first direction side. In order to suppress transfer of heat from the energy storage device 100 or secure an insulating property, it is sometimes preferable that the length of the end spacer 300 in the second direction is not shortened. On the other hand, since the length of the end member 400 in the second direction can be made shorter than that of the end spacer 300, the terminal block 320 can be disposed by utilizing the space on the second direction side of the end member 400. By disposing the terminal block 320 on the second direction side of the end member 400, it is possible to suppress an increase in the length of the energy storage apparatus 10 in the first direction. With such a configuration, space saving (improvement of the energy density) of the energy storage apparatus 10 can be realized with a simple configuration.

More specifically, it is as follows. The end member 400 is required to receive and support a force accompanying the swelling of the energy storage device 100. The force with which the energy storage device 100 tends to swell is maximum at the center of the long side surface of the energy storage device 100 and decreases toward the four corners. Therefore, in order to dispose the external terminal 910 without impairing the function of the end member 400, it is preferable to dispose the external terminal 910 at any of the four corners. Among them, it is more preferable to dispose the external terminal 910 on the electrode terminal 120 side since the length of the bus bar 920 connected from the electrode terminal 120 to the external terminal 910 can be minimized by providing the external terminal 910 at the corner portion on the side where the electrode terminal 120 is disposed. Therefore, by disposing the terminal block 320 at the corner on the Y-axis plus direction side, the total overall length of the energy storage apparatus 10 including up to the terminal block 320 for the external terminal 910 can be made smaller than the conventional cases without impairing the function of the end member 400, and the energy density can be further improved.

The external terminal 910 of the energy storage apparatus 10 is formed integrally with the terminal block 320 of the end spacer 300. As described above, the number of components can be reduced by integrally forming the external terminal 910 with the terminal block 320 of the end spacer 300. Accordingly, the energy storage apparatus 10 having a simple configuration can be realized. Since the external terminal 910 can be fixed to the end spacer 300, when an external member (such as a bus bar) is connected to the external terminal 910, the external terminal 910 can be prevented from rotating or moving.

More specifically, it is as follows. Since the external terminal 910 is formed integrally with the terminal block 320, the external terminal 910 can be easily supported with sufficient mechanical strength. If the integration method is insert molding, the external terminal 910 and the terminal block 320 are in close contact with each other without any gap, so that the torque applied to the external terminal 910 can be received by the entire terminal block 320 around the external terminal 910, and the external terminal 910 can be supported more firmly. When the external terminal 910 is formed integrally with the terminal block 320, sufficient withstand voltage strength can be easily secured. If the integration method is insert molding, the external terminal 910 and the terminal block 320 are in close contact with each other without any gap, and the mechanical strength for supporting the external terminal 910 is also improved. Therefore, sufficient withstand voltage strength can be further secured, and occurrence of a leakage current and a spark caused by the gap between the external terminal 910 and the terminal block 320 can be prevented. In addition, since the external terminal 910 is formed integrally with the terminal block 320, not only the number of components can be simply reduced, but also the strength, assembling accuracy, and the like of the terminal block 320 itself are improved as compared with the case where the terminal block 320 as a separate member is disposed, the total overall length of the energy storage apparatus 10 including up to the terminal block 320 for the external terminal 910 is made smaller than the conventional cases, and the energy density can be improved.

### 5 Description of Modification Example

Although the energy storage apparatus 10 according to the present embodiment has been described above, the present invention is not limited to the above-mentioned embodiment. That is, the embodiment disclosed herein is illustrative in all respects and is not restrictive, and the scope of the present invention is defined by the claims, and includes all modifications within the meaning and scope equivalent to the claims.

In the above-mentioned embodiment, the bus bar 920 which is disposed inside the end spacer 300 is a bus bar which connects the electrode terminal 120 of the energy storage device 100 and the external terminal 910 of the energy storage apparatus 10. However, the bus bar 920 may be a bus bar which connects the electrode terminals 120 of the two energy storage devices 100 to each other. Alternatively, the bus bar 800 or a bus bar different from the bus bars 800 and 920 may be disposed inside the end spacer 300.

In the above-mentioned embodiment, the bus bar 920 is disposed inside the spacer located at a position where one energy storage device 100 is sandwiched between the bus bar 920 and another energy storage device 100, that is, inside the end spacer 300. However, the bus bar 920 may be disposed inside a spacer disposed at a position sandwiched between one energy storage device 100 and another energy storage device 100, that is, inside the intermediate spacer 200. Alternatively, the bus bar 800 or a bus bar different from the bus bars 800 and 920 may be disposed inside the intermediate spacer 200.

In the above-mentioned embodiment, the end spacer 300 includes the terminal block 320, and the bus bar 920 is disposed inside the terminal block 320. However, the end spacer 300 may not include the terminal block 320, and the bus bar 920 may be disposed inside the spacer body portion 310 or the like.

In the above-mentioned embodiment, the bus bar 920 is formed integrally with the end spacer 300 by being insert-molded in the end spacer 300 to be embedded in the end spacer 300 and disposed inside the end spacer 300. However, the bus bar 920 only needs to be disposed inside the end spacer 300, and may not be insert-molded in the end spacer 300, may not be embedded in the end spacer 300, or may not be formed integrally with the end spacer 300.

In the above-mentioned embodiment, the bus bar 920 (and the terminal plate portion 911 of the external terminal 910) is formed by bending one plate-like member, but may be formed by connecting a plurality of plate-like members.

In the above-mentioned embodiment, the terminal column portion 912 of the external terminal 910 projects in the Z-axis plus direction, but may project in any direction such as the Z-axis minus direction, the X-axis direction, or the Y-axis direction.

In the above-mentioned embodiment, the terminal block 320 is disposed on the Y-axis plus direction side of the end member 400. However, the arrangement position of the terminal block 320 is not particularly limited, and the terminal block 320 may be disposed so as to project in the direction directed to the energy storage device 100 and may be disposed on the Y-axis plus direction side of the energy storage device 100.

In the above-mentioned embodiment, both the X-axis plus direction side and the X-axis minus direction side of the energy storage apparatus 10 have the above-mentioned configuration, but either one of the X-axis plus direction side and the X-axis minus direction side of the energy storage apparatus 10 may have a configuration different from the above-mentioned configuration.

A form constructed by freely combining the components included in the above-described embodiment and its modification examples is also included in the scope of the present invention.

The present invention can be realized not only as such an energy storage apparatus 10 but also as the end spacer 300 and the bus bar 920 included in the energy storage apparatus 10.

### INDUSTRIAL APPLICABILITY

The present invention can be applied to an energy storage apparatus or the like including an energy storage device such as a lithium ion secondary battery.

### DESCRIPTION OF REFERENCE SIGNS

10: energy storage apparatus
100: energy storage device
120: electrode terminal
200: intermediate spacer
300: end spacer
310: spacer body portion
320: terminal block
321: terminal block first wall portion
322: terminal block second wall portion
323: terminal block third wall portion
400: end member
800, 810, 920: bus bar
900: terminal member
910: external terminal
911: terminal plate portion
912: terminal column portion
921: external terminal side plate portion
922: energy storage device side plate portion

1. An energy storage apparatus comprising:
an energy storage device;
a spacer disposed on a side of the energy storage device in a first direction; and
a bus bar connected to the energy storage device,
wherein at least a part of the bus bar is disposed inside the spacer.

2. The energy storage apparatus according to claim 1, further comprising a plurality of energy storage devices arranged in the first direction.

3. The energy storage apparatus according to claim 1,
wherein the bus bar is a bus bar which connects an electrode terminal of the energy storage device and an external terminal of the energy storage apparatus, and
wherein at least a part of the bus bar between the electrode terminal and the external terminal is disposed inside the spacer.

4. The energy storage apparatus according to claim 1, wherein the spacer includes a terminal block on which an external terminal of the energy storage apparatus is disposed.

5. The energy storage apparatus according to claim 4, further comprising an end member disposed at an end of the energy storage apparatus in the first direction,
wherein the terminal block is disposed on a side of the end member in a second direction intersecting with the first direction.

6. The energy storage apparatus according to claim 4, wherein the external terminal is formed integrally with the terminal block.

7. The energy storage apparatus according to claim 1, further comprising a plurality of energy storage devices arranged in the first direction,
wherein the spacer is disposed outside the energy storage device disposed at an end of the plurality of energy storage devices in the first direction.
